(19) United States
(12) Patent Application Publication
(10) Pub. No.: US 2016/0094531 A1
(43) Pub. Date: Mar. 31, 2016

(54) CHALLENGE-BASED AUTHENTICATION FOR RESOURCE ACCESS

(71) Applicant: Microsoft Technology Licensing, LLC, Redmond, WA (US)

(72) Inventors: Mahesh Unnikrishnan, Sammamish, WA (US); Arun Nanda, Sammamish, WA (US)

(73) Assignee: Microsoft Technology Licensing, LLC, Redmond, WA (US)

(21) Appl. No.: 14/607,549

(22) Filed: Jan. 28, 2015

Related U.S. Application Data
(60) Provisional application No. 62/057,034, filed on Sep. 29, 2014.

(51) Int. Cl. H04L 29/06; H04L 9/32; G06F 21/31

(52) U.S. Cl. CPC H04L 63/08; G06F 21/31; H04L 63/10; H04L 9/3247

(57) ABSTRACT

Examples of the present disclosure describe systems and methods for authentication by an authentication component when a client attempts to access a secured resource(s). As an example, an access request is received from a client at an authentication component. The authentication component generates an authentication challenge including criteria to assist the client in selecting an appropriate authentication credential, a request for proof of possession of the authentication credential, and challenge-specific data for the client to return in a challenge response. A challenge response is received from the client. The authentication component evaluates the challenge response and determines whether to authenticate the client for access to a resource based on the evaluated challenge response. Other examples are also described.

### BACKGROUND

Clients may launch applications that require access to secured resources. In some cases, authorization services may be unable to authenticate a client seeking access to such secured resources adequately due to the nature of the application the client is using. Otherwise, authorization or authentication systems and services may benefit from improved or augmented authentication mechanisms. It is with respect to this general technical environment that the present application is directed.

### SUMMARY

Examples of the present disclosure describe systems and methods for authentication by an authentication component when a client attempts to access a secured resource(s). As an example, an access request is received from a client at an authentication component. The authentication component generates an authentication challenge including criteria to assist the client in selecting an appropriate authentication credential, a request for proof of possession of the authentication credential, and challenge-specific data for the client to return in a challenge response. A challenge response is received from the client. The authentication component evaluates the challenge response and determines whether to authenticate the client for access to a resource based on the evaluated challenge response.

In another example, an exemplary system of the present disclosure comprises a device having a memory and a processor. The processor is configured to suppress an authentication challenge when the authentication artifact is presented corresponding with a request for access to a secured resource. The processor is further configured to determine whether a client associated with the request is authenticated, and evaluate the authentication artifact to determine whether the authentication artifact is valid. The device determines that the authentication artifact is valid when the authentication artifact presented is an authentication artifact that was issued to the client requesting access to the secured resource. The device grants access to the secured resource when the client is authenticated and the authentication artifact is valid. In yet another example, the device requires the client to re-authenticate when at least one of, the client fails authentication and the authentication artifact is determined to be invalid, occurs. If the device determines that the client is to authenticate or re-authenticate, the device issues an authentication challenge.

Yet another non-limiting example describes a computer-readable storage device, having instructions thereon, which when executed on a process cause the processor to execute a process. The process executed comprises storing data extracted from a received authentication challenge. The stored data extracted from the received authentication challenge is modified. An access request is generated including the modified stored data and the generated access request is transmitted for authentication.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of a system that may be used to grant access to secured resources as described herein.

FIG. 2 illustrates a method of interaction between a client and an authentication component as described herein.

FIG. 3 illustrates a method for request generation and response processing performed by a client as described herein.

FIG. 4 illustrates a method for request and challenge processing performed by an authentication component as described herein.

FIG. 5 is a block diagram illustrating an example of a computing device with which aspects of the present disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

### DETAILED DESCRIPTION

The present disclosure describes authentication of clients and client services (e.g., applications). Examples of the present disclosure enable application of complex authentication (e.g., one or more levels of authentication) for stronger authentication as well as improve a user-interface experience for a client. As an example, mechanisms and protocols associated with the present disclosure provide a way for authorization systems or services to authenticate a client, for example a device of a client. In other examples, mechanisms and protocols of the present disclosure provide for compound authentication (e.g. more than one level of authentication, for example, where at least a device of the client and a user of the client may be evaluated for authentication.

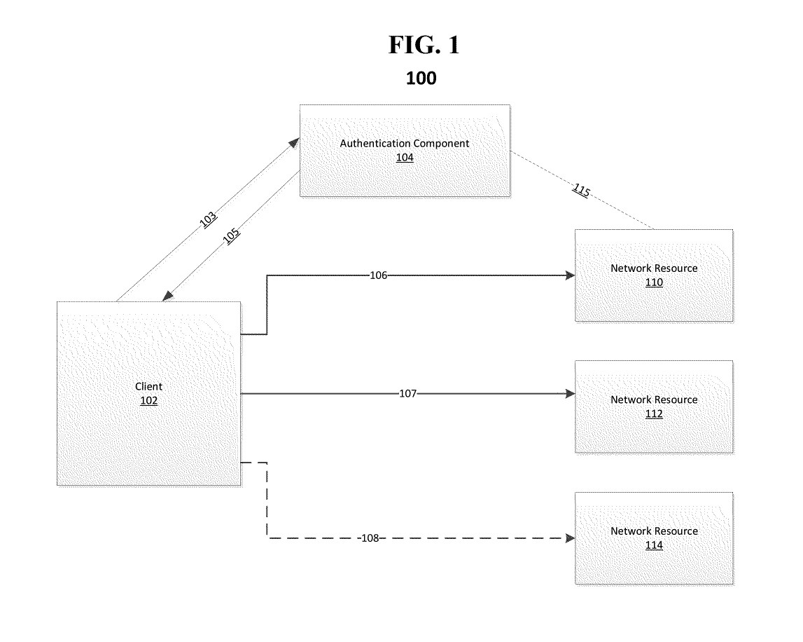

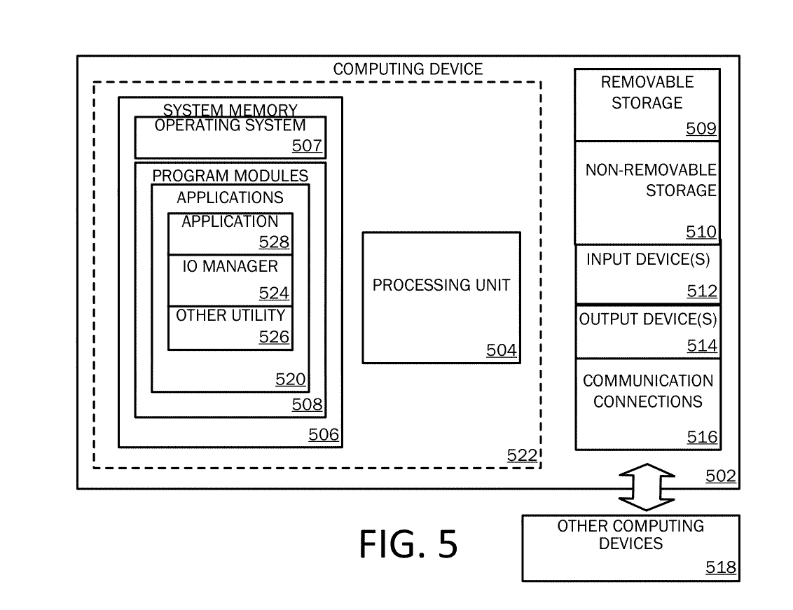

FIG. 1 illustrates an overview of a system 100 that may be used to grant access to secured resources of a network. The system 100 is a combination of interdependent components that interact to form an integrated whole. Components of the system 100 may be hardware components or software implemented on hardware components of the system 100, and connect with other components of the system 100 via a network. The network may be any configuration of data connections that allow components of the system 100 to pass data to and receive data from other components of the system 100. As an example, a network may be a distributed environment that includes resources shared by more than one client such as a cloud-computing environment. Hardware components of the system 100 possess means for implementing a software process or program such as an application or service to run thereon. Please refer to FIGS. 5-7 for additional examples of hardware that may be implemented in the system 100. As one example, the system 100 may include components such as a client 102, an authentication component 104, and network resources 110, 112 and 114. However, the system 100 is not limited to such an example. The scale of systems such as system 100 may vary and include more or less components than are described in FIG. 1.

The client 102 of the system 100 may run applications or seek access to other components or services of the system 100 or external resources of the system 100 such as the Internet. Examples of hardware components may include but are not limited to any processing device (e.g., having a processor or micro-processor), and any network or internet connected device among others. The client 102 may also be a component such as a virtual machine, application, application programming interface (API) or service such as a web-based service, among other examples. Operating system software, web browser applications or other web-based applications such as Rich Internet Application (RIA) are examples of services or applications that may be run upon the client 102. In at least one example, a user of the client 102 may be an operating system, an application or a service running upon a processing device such as a computer, laptop, mobile phone, tablet, etc. The client 102 may seek to access a resource internal or external to the network, for example network resources 110, 112 or 114. Network resources 110, 112, 114 may be secured or unsecured resources of the system 100. Access to such resources may be policy-based and subject to administrator control. In an exemplary system such as system 100, network resources 110, 112 and 114 are secure resources that are secured by an authentication component 104. In the example system 100, the client 102 is connected with the authentication component 104 and network resources 110, 112 and 114. In alternative examples, multiple clients may be included in a system such as system 100.

The authentication component 104 is hardware or software component of the system 100 that provides validation or authentication when a client 102 or other component of the system 100 attempts to access a resource such as network resources 110, 112 or 114. An exemplary authentication component 104 may be a computing device such as a server that is a centralized resource of the system 100. However, in alternative examples, the authentication component 104 may be multiple components of the system 100 providing a unified function of safeguarding access to resources of the system 100. The authentication component 104 may also be software-based configured to run remotely on a hardware component of the system 100.

The authentication component 104 implements authentication mechanisms or protocols to enforce authentication or validation of the client 102 to access resources such as network resources 110, 112 or 114. As examples, the authentication component 104 may perform complex authentication where one or more levels of authentication are enforced using multiple pieces of enforcement criteria. Enforcement criteria may include any data or information that is usable to authenticate the client 102. Enforcement criteria may be flexibly set, for example based on network policies or by administrator, and included in challenges presented by the authentication component 104 to authenticate the client 102. Levels of authentication performed by an authentication protocol may include compound authentication (e.g., device authentication and one or more factors of user authentication). The authentication component 104 may implement an authentication mechanism or protocol to provide access to components and applications of the system 100. The authentication component 104 may be federated or un-federated and enable functionalities including single sign-on in certain cases. In one example, the authentication resource 104 may authenticate a client 102 based on a set of claims about its identity contained in security identification such as a device certificate or trusted token.

When a client 102 of the system 100 seeks access to a network resource, an access request is sent to the authentication component 104 to authenticate the client 102 to access the network resource. Communication line 103 illustrates the interaction of transmitting data from the client 102 to the authentication component 104. As an example the client 102 may send a request such as an access request to be authenticated by the authentication component 104. When the authentication component 104 receives the access request, it generates a challenge to send back to the client 102 usable to authenticate the client 102. Communication line 105 of FIG. 1 illustrates a data transmission from the authentication component 104 to the client 102, for example where the data transmission may be a challenge to authenticate the client 102. As an example, the challenge may be a challenge to authenticate a client device. A client device may be a processing device or any other electrical component configured to run an application or service usable by the client 102. However, the challenge may be used to authenticate any aspect of the client 102 component as the authentication protocol may flexibly apply different challenge criteria to a challenge issued to the client 102. Once the client 102 receives the issued challenge, the client 102 constructs a response to the challenge and transmits the response to the authentication component 104. Communication line 103 shows a data transmission from the client 102 to the authentication component 104. As an example of a data transmission shown by communication line 103, the client 102 may send the response to the challenge to the authentication component 104.

Upon receiving the response, the authentication component 104 evaluates and processes the response. In an example where the authentication component 104 is evaluating a device of the client, the authentication component 104 may evaluate the device of the client based on the enforcement criteria. As examples, enforcement criteria may include credentials of device of the client and challenge-specific data sent by authorization component 104 to the client 102 in the issued challenge. The authentication component 104 may determine whether the client 102 is authenticated or not. An authentication protocol may include policy rules to guide the authentication component 104 in determining whether to authenticate the client 102. If the client 102 is authenticated, the authentication component 104 may issue a security authorization to the client 102 to allow access to a secured network resource such as network resource 112. Examples of a security authorization may include but are not limited to an authentication artifact (e.g. an authentication cookie, single sign-on token, etc.), an access token, a cryptographic hash of data, a cryptographic signature of data or a certificate. The client 102 may present the security authorization to a network resource to be granted access to the network resource. As an example, communication line 106 illustrates a communication between the client 102 and network resource 110, for example where the client 102 seeks access to network resource 110. As another example, communication line 107 illustrates a communication between the client 102 and network resource 112, for example where the client 102 seeks access to network resource 112. As yet another example, communication line 108 illustrates a communication between the client 102 and network resource 114, for example where the client 102 seeks access to network resource 114. In some cases, even if the client 102 fails authentication, access may still be granted to a network resource. In that instance, the authentication protocol may identify that a network resource may allow access to unauthenticated or untrusted clients. Access rights may be specified in the protocol, for example, by an administrator.

In alternative examples of the system 100, network resources such as network resources 110, 112 and 114 may communicate with the authorization component 104. For example, the system 100 may be configured to allow a client 102 to present an access request directly to a network resource 110 as shown by communication line 115 of FIG. 1. In such an example, a network resource such as network resource 110 may interface with the authentication component 104 to receive authentication on behalf of the client 102 before allowing access.

In other examples, a client 102 may seek access to more than one of the network resources 110, 112 and 114. Typically, this would require that the client 102 be authenticated to access each network resource it wishes to access. However, the authentication protocol implemented by the authentication component 104 may enable optimistic authentication of the client 102. Optimistic authentication is an authentication improvement that can avoid extra challenge/response round-trips when the authentication component 104 determines that a client 102 is authenticated. The authentication protocol may be configured such that the authorization component 104 may accept an authentication response from the client 102 even when the authorization component 104 has not issued a challenge for access to a network resource.

In an example of optimistic authentication, when the client 102 receives an initial authentication challenge from the authentication component 104, it can remember data associated with the challenge (including enforcement criteria), and as an example, persist such data into a storage of the client 102. The client 102 would then be able to invoke a future response without being prompted by a challenge from the authentication component 104. As an example, an access request sent to the authentication component 104 may include a response based on a modification of a prior challenge. In some examples, the initial challenge may comprise a nonce or expiration time in a location known to the client 102. The client 102 may generate a future challenge response by generating a response challenge based on the initial challenge and an expiration time that replaces the expired expiration time. Optionally, the client 102 may determine a range of bytes within opaque data of the prior challenge that it should remove/replace. As another example, the client 102 may determine a range of bytes to remove/replace from the non-opaque data of the prior challenge. The client 102 may add to (or replace at least some of) the opaque or non-opaque data (e.g., current timestamp) of the prior challenge. The client 102 may then processes the modified/combined data instead of the original prior challenge data to generate an optimistic authentication challenge response that is sent with or as the initial access request. Configuration of the authentication protocol of the authentication component 104 may enable optimistic authentication.

In another example of optimistic authentication, client 102 may issue an access request for access to network resource 110. The authentication component 104 may issue a challenge, evaluate a response from the client 102, and authenticate the client 102 based on the client response. In some examples, when the authentication component 104 issues a security credential or authentication artifact to an authenticated client to access network resource 110, the authentication component 104 may provide the client 102 with opaque data (e.g., authentication artifact such as authentication session cookie/single sign-on token) acknowledging that the client 102 was authenticated by a challenge issued by the authentication component 104. Based on policy rules of the authentication protocol, the authentication component 104 may allow a client 102 to access more than one resource based on satisfaction of a single challenge. The opaque data provides context for authentication purposes and in one example may be included in transmissions by the client 102 so that new challenges are not required to be issued for an already authenticated client. The lifetime of the opaque data may also be limited by the authentication component 104 for improved security.

Alternatively, in other examples, the authentication component 104 may be configured to deny optimistic authentication. In that case, the authentication component 104 would simply issue another authentication challenge to validate the client 102 when the client 102 wishes to access another network resource.

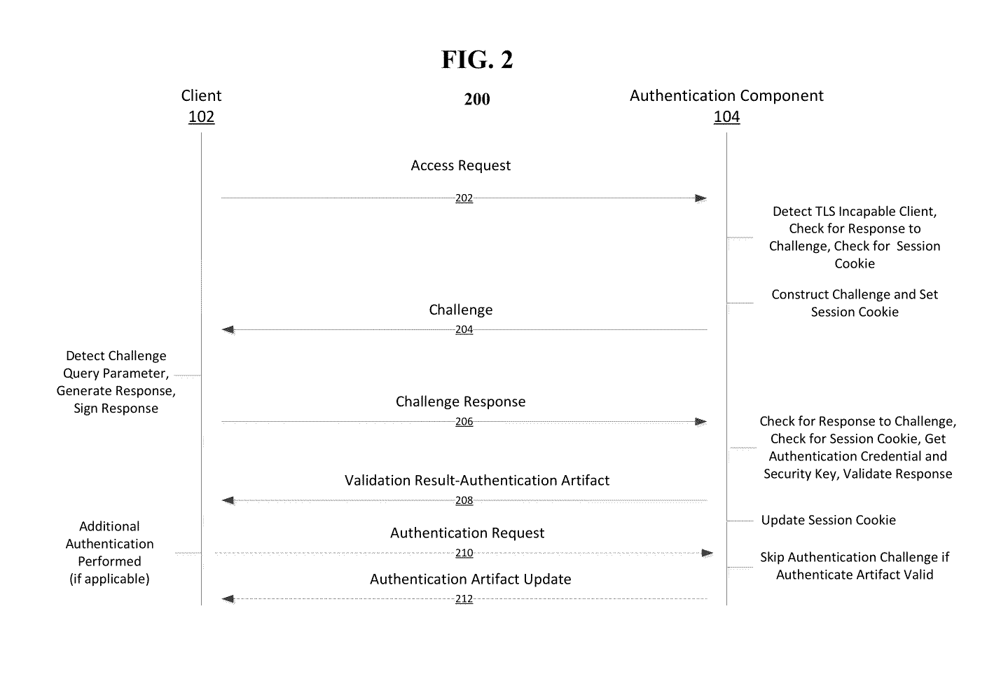

FIG. 2 illustrates a method 200 between a client and an authentication component to authenticate the client for access to a resource. A client, such as client 102 of FIG. 1, may request authorization to access a resource that is secured by an authentication component such as authentication component 104 (of FIG. 1).

Method 200 begins at operation 202, where a client such as client 102 of FIG. 1 generates an access request that is sent to an authentication component such as the authentication component 104 of FIG. 1. The client 102 may initiate an access request by launching an embedded application. In one example, a client 102 may be using a web-based browser application to obtain access to a resource(s), where control (e.g., web-view control) is implemented that hosts content of a markup language (e.g., HTML or XML) in an application for use by the client 102. In another example, a client 102 may be using a code-based application such as a rich application to obtain access to a resource(s). However, any service-based application may be used by the client 102 to authenticate access to network resources. The authentication component may be associated with any identity provider (IDP) that provides authentication services. IDPs may include but are not limited to Active Directory Federation Services (ADFS), Azure Active Directory, Open Directory, Apache DS, FaceBook, YahooID, GoogleID, OpenID, OpenLDAP, among other IDPs. Depending on whether the authentication component 104 is federated or un-federated, the application of the client may implement redirects that may occur before the client 102 is directed to the authentication component 104. Ultimately, the access request made by the client 102 is appropriately directed to the authentication component 104.

The access request may specify whether the application being run by the client 102 is capable of performing authentication using an authentication protocol implemented by the authentication component 104. As examples, the authentication protocol implemented by the authentication component 104 may be public key-based or private-key based, where keys may be used by the client 102 to generate a response to a challenge by the authentication component 104 and the authentication component 104 may use keys to validate or authenticate the client 102. The application of the client 102 may automatically specify or alternatively allow the client to manually specify an ability to be authenticated using a specific authentication protocol of the authentication component 104. In a case where the application being run by the client 102 is web-browser based, the client 102 or application of the client 102 may append a user agent string or special data string in the access request to indicate that it is able to authenticate using the authentication protocol, for example receive challenges issued by an authentication protocol. Version negotiation may be implementable in some IDPs. As an example, the client 102 may also specify the version of the authentication protocol supported by it in its access request to the authentication component 104. In an example where the client 102 is running a code-based application, the client 102 or application of the client 102 may set a custom header (e.g., HTML header) to signal an ability to respond to challenges of a specific authentication protocol. If an application of a client is incapable of performing authentication using a specific authentication protocol, the authentication component 104 attempts to authenticate the client 102 by a transport layer service (TLS) mechanism such as a TLS challenge.

Once an authentication component 104 receives an access request from a client, the authentication component may inspect the access request and specifically identify whether the client's application is able to be authenticated using a specific authentication protocol. As examples, the authentication component 104 may detect a capability to respond to a specific authentication protocol of the authentication component 104 by inspecting a user string or header of the access request. Before generating a challenge to the client's access request, the authentication component 104 may check whether the client 102 has issued a response to a previous challenge or if opaque data such as an authentication session cookie has been generated that indicates a state of a request or challenge previously issued. The authentication component 104 may handle management of challenges based on policy rules governing the authentication component 104, for example set by the authentication protocol.

The authentication component generates an authentication challenge to authenticate a client for access to a secured resource. Once the authentication component 104 has generated an authentication challenge for the client 102, flow of method 200 continues to operation 204 where the authentication challenge is sent to the client 102. The authentication challenge is presented in a flexible format that can be tailored to a specific type of authentication (or multiple types of authentication). Parameters of the authentication challenge may vary, for example, depending on the application that the client 102 is running or the type of authentication the authentication protocol is determining. The challenge contains information about the requested enforcement criteria to aid the client 102 in determining an authentication credential being requested by the authentication component 104. The challenge includes information that would allow the client 102 to easily locate the authentication credential required to authenticate the client 102 such as data related to an issuer of an authentication credential as an example. The challenge may also include challenge-specific data that the client 102 uses in a challenge response as criteria to authenticating the client 102. This includes secured data that is opaque to the client 102 (e.g., encrypted data). Examples of some of the parameters that may be included in an exemplary authentication challenge are highlighted in Table 1.1 below:

TABLE 1.1

| Challenge field | Value |
|---|---|
| Nonce | A unique value issued by the server in its challenge. |
| | The client is expected to return this value to the |
| | server in its signed response in order to perform |
| | authentication. The nonce is also persisted within |
| | the encrypted context parameter. |
| Version | The version number of the challenge-response |
| | based authentication protocol. This is set to |
| | 1.0 as an example. |
| CertAuthorities | List of certificate issuers of the authentication |
| | credential that are trusted by the authorization |
| | component. This is intended to help the client |
| | select the appropriate authentication credential |
| | to be presented in its response to the authentication |
| | challenge. |
| CertThumbprint | The thumbprint of the device certificate that the |
| | client produces in order to provide proof of |
| | possession to the authorization component when |
| | redeeming security credentials for access to a |
| | resource. |
| Context | An encrypted blob containing context maintained |
| | by the authentication component for the request. |
| | The blob is opaque to the client and the client is |
| | expected to replay the blob to the authentication |
| | component in its response. |
| Submit URL | The URL to which the client submits its response |
| | to the authentication challenge. The authentication |
| | component uses the same URL to which the client |
| | submitted its request before the challenge was |
| | generated. |

As an example, the authentication protocol may implement a device authentication mechanism to authenticate a device of the client 102. Examples of protocols that may implement device authentication include iterations of SAML-P, WS-Federation, and OAuth/OpenID Connect etc., however device authentication may be configured to be implemented with other authentication protocols as well.

The authentication challenge is designed to be short lived and the authentication component 104 may also maintain state information in a manner that is opaque to the client 102, for example within an authentication session cookie or the encrypted context parameter of the challenge that ensures the challenge is short lived. The authentication session cookie is also used to persist state across the multiple redirects that are involved in completing compound authentication (e.g., user and device authentication—including multiple-factor authentication), ensuring that an authentication challenge is not issued more than once for a given authentication session. The authentication session cookie may maintain context across multiple calls and perform validation checks when the client 102 responds to the authentication challenge. As an example, the authentication session cookie is encrypted by the authentication component 104, for example in a manner similar to how persistent and session single sign-on (SSO) tokens are encrypted. Examples of parameters and data maintained by an example authentication session cookie are highlighted below in Table 1.2 below:

TABLE 1.2

| Field | Value |
|---|---|
| State | The current state of authentication for the client. |
| | Possible values are: |

challenged
done
incapable

| | |
|---|---|
| | The state value in the cookie is used to ensure that the |
| | client is not prompted to perform authentication for the |
| | duration of the session until all the redirects required |
| | to complete user authentication are complete. |
| clientid or | The identifier of the client or device of the client |
| deviceid | that was authenticated. This field is expected to be set |
| | to a valid value only if the state is ‘done’. The identifier |
| | is used to query the client object if required when |
| | processing a subsequent redirect for user authentication. |
| Policyid | An identifier of a policy rule (or set of rules) the |
| | authentication component uses for the authentication |
| Nonce | The unique value that was issued by the authentication |
| | component in its authentication challenge. |
| Iat | Timestamp at which the authentication session cookie was |
| | issued. This enables the authorization component to reject |
| | cookies that are older than the allowable lifetime of an |
| | authentication session cookie. |

Moreover, the format of an authentication challenge may vary, for example, depending on the application the client 102 is running Format and parameters of the authentication challenge are flexible and may be tailored to accommodate various authentication scenarios. In an example format of the authentication challenge provided for a web-browser based application, an HTTP 301 redirect may be used similar to the following:

HTTP/1.1 302 Found
Location: urn:http-auth:PKeyAuth?Nonce=<noncevalue>
&CertAuthorities=<distinguished names of CAs>&Version=1.0
&SubmitUrl=<URL to submit response>&Context=<server state that client
must convey back>

In an alternative example, the format of the authentication challenge provided for a code-based application may implement a challenge similar to an HTTP 401 response such as:

HTTP/1.1 401 Unauthorized
WWW-Authenticate: PKeyAuth Nonce=”<nonce value>”, Version=”1.0”,
CertThumbprint=”<thumbprint of device certificate>”, Context=”<server
state that client must convey back>”

The authentication protocol of the authentication component 104 may apply rules to challenge processing. For example, the protocol specifies rules that the client 102 follows to authenticate and be granted access to a network resource. As an example, the authentication component 104 requires that request parameters originally sent in the authentication challenge must be preserved and sent back in a challenge response using a parameter specified in the authentication challenge. As another example, the authentication component 104 may also provide rules regarding a format for returning a response to an authentication challenge.

Continuing flow of method 200, the authentication component 104 sends the authentication challenge to the client 102. The client 102 may detect challenge query parameters, generate a response to the challenge, and sign the generated response.

As an example, the authentication component 104 may send a device authentication challenge to the client 102 to authenticate a device of the client 102. The client 102 operating its application may receive notification events generated by its browser control or code-based application. When the client application notices a redirect containing the device authentication challenge (i.e. a redirect to the custom URI ‘url:http-auth:PKeyAuth’), it realizes that device authentication is to be performed. Upon receiving a device authentication challenge from the authentication component 104, the client 102 may use the data in the authentication challenge to locate an authentication credential to authenticate the device of the client 102. The authentication component 104 may require that the client 104 provide the authentication credential to verify proof of possession of the authentication credential. The client 102 retrieves the appropriate device authentication credential (e.g., device certificate) corresponding to the enforcement criteria or authentication criteria specified by the authentication component 104 (e.g., the trusted issuers value or the certificate thumbprint specified by the authentication component 104).

The client then constructs a response to the challenge where the response includes at least the authentication credential that is specific to the client 102 and challenge-specific data included in the authentication challenge that the authentication protocol may require to complete authentication of the client 102, for example a device of the client 102. As an example, the authentication credential may be associated with a key (e.g., public key or private key) of the client 102. For generation of the response, the authentication component 104 may require specific data types or fields to be appropriately completed. In some examples, if the correct format and data types are not completed for the response, the client device may not be authenticated.

The client 102 may sign the challenge response in accordance with signing specifications of the authentication protocol. In one example, the client 102 may construct a JSON Web Token (JWT) to respond to the authentication challenge. A JWT is a compact, URL-safe means of representing claims to be tranferred between multiple parties. The JWT may include data such as a JSON Web Signature (JWS) header, a payload and a JWS signature.

The client 102 may further sign the generated response in accordance with the specifications of the authorization protocol and using a key. The signing feature implemented by the authentication protocol is a mechanism that is independent of the type of content that is being signed for authentication. As an example, the signature of the client 102 may be included in a header of the response to the authentication challenge. In one example, the authentication credential such as the device certificate is included within the header of the response.

In one example, the client 102 constructs a JWS to sign the response. JWS is a means of representing content secured with digital signatures or Message Authentication Codes (MACs), and is a signature format usable for space constrained environments such as HTTP Authorization Headers and Uniform Resource Identifier (URI) query parameters.

The client 102 may generate a JSON object containing the JWS headers specified in the following table and the following encoding is performed:
Unicode parts of this object are converted into UTF-8 as defined in RFC 3629.
The UTF-8 representation of the JSON object is then encoded using Base64Url encoding as defined in the JWS specification.
   In an example JWS constructed for the response, the JWS header may of include the following fields:
a. alg: This is set to the algorithm that will be used for signing the JWT. It is a hint to the authentication component regarding how the signature was generated.
b. typ: The client sets the typ header to ‘jwt’ in order to signify that the signed content is a JWT.
c. x5c: The public device certificate that was used to sign the response is specified using this field. This helps the authentication component locate the corresponding device object in the directory, validate the signature on the response using the public key and ensure that it can process the device authentication request.
   The payload of the authentication response may include data that the authentication component 104 may require to authenticate the client 102. For example, the payload of the response may include challenge-specific data that the client 102 returns to authentication component 104 in the response based on the challenge. Data that may be included in the payload is variable and the authentication protocol of the authentication component 104 may specify parameters of data to be included in the payload. Using a JWT as an example, the payload may be a Base64Url encoded JWT (JSON Web Token) with the data similar to the following fields as shown in Table 1.3:

TABLE 1.3

| JWT field | Value |
|---|---|
| Aud | As example, may be set to: |

Federation service identifier received via the fs_name
field of the challenge JSON object.
Endpoint of the authentication component.

| | |
|---|---|
| Nonce | The nonce issued by the server in its challenge is passed |
| | on unmodified to this field in the response by the client. |
| Iat | Timestamp for when the authentication response was |
| | generated by the client. |

The authentication protocol may require implementation to seal the response (e.g., by encryption). Continuing the example where a JWT is signed by a JWS signature, the client 102 may compute a JWS Crypto Output in the manner defined by the authentication protocol for the particular algorithm being used (i.e. the algorithm referenced by the ‘alg’ field in the JWS header). As an example, the JWS Signing Input may be concatenated with the JWS Header.

Flow may continue with operation 206 where the challenge response is sent by the client 102 to the authentication component 104. In an example, where the application of the client 102 is web-browser application, the client 102 may use web browser control to navigate the response to the authentication component 104. As an example, in sending the response to the authentication component 104, the client 102 may place the authentication response in an authorization header of a request. An example of the content provided in the authentication response is the following:

Authorization: PKeyAuth AuthToken=”<signed JWT>”, Context=”<same
value as in the challenge>”, Version=”1.0”

The authentication component 104 evaluates the authentication response once it is received. The response may be evaluated based on rules established by the authentication protocol of the authentication component 104. The authentication component 104 evaluates the response to determine that the response is authentication protocol compliant, for example, determining whether the response includes protocol identification in the header or a user substring appended to the response. Further, the authentication component 104 checks to verify that the authentication response is signed, for example, using an encryption algorithm such as JWS. If a security credential such as token is not included with the response, then the client 102 fails authentication.

After the authentication component 104 validates that the response is received in the appropriate form and the response is correctly signed, the authentication component 104 extracts the authentication credential from the response. In an example, extraction of the authentication credential includes extracting an object of the authentication credential (e.g., certificate or device thumbprint) and key data associated with the authentication credential. The authentication component 104 may use the key data (e.g., public key or a hash of a public key) sent by the client 102 to locate client-specific data maintained by the authentication component 104 (e.g., stored in a storage or directory associated with the authentication component 104). The authentication component 104 validates the extracted authentication credential against data maintained by the authentication component 104, for example by comparing authentication data stored by the authentication component 104 with the authentication credential extracted from the response to the authentication challenge. In an example, the authentication component 104 may access a storage or directory and use the extracted authentication credential to authenticate the authentication credential of the client 102. In that example, if the authentication credential is verified using the storage or directory of the authentication component 104, the authentication component 104 evaluates data of the client 102 stored in the directory or storage. For instance, if a device of the client 102 is the subject of authentication, the authentication component 104 may determine whether the device of the client 102 has been marked as lost or stolen, or alternatively is able to be trusted. As an example, the authentication component 104 may choose to deny access to lost or stolen devices.

Further, the authentication component 104 validates the signature of the response provided by the client 102. The authentication component 104 may validate the signature of the response using a key such as a public key maintained by the authentication component 104.

Moreover, to authenticate the client 102 the authentication component 104 may also evaluate data that is opaque to the client 102 and included in with the response or the authentication session cookie a session cookie is applicable. As an example, the data opaque to the client 102 may be the authentication session cookie or a ‘Context’ parameter described above with respect to parameters included in an authentication challenge. The authentication component 104 validates the challenge-specific data received in the response from the client 102 against the Context parameter or authentication session cookie. For example, the authentication component 104 may apply policy rules set by the authentication protocol or administrator to the data included in or with the authentication challenge. The authentication component 104 may verify that authentication policies are still applicable. As examples of parameters that the authentication component 104 validates in the Context parameter or authentication session cookie, the authentication component 104 may include evaluation such as:
Check whether the challenge has expired including validation of the timestamp;
Validate the ‘nonce’ field in the authentication response against a nonce value persisted in context parameter maintained by the authentication component 104.

Once the authentication component 104 has evaluated the authentication response and the opaque data/authentication session cookie (if one is included), the authentication component 104 generates a validation result to send back to the client 102 indicating whether the client 102 is authenticated or not.

Flow of method 200 proceeds to operation 208 where the authentication component 104 transmits the validation result to the client 102. The authentication component 104 updates the opaque data/authentication session cookie and may transmit the updated opaque data/authentication session cookie to the client 102 as an authentication artifact identifying that the authentication component 104 has provided a level of authentication for the client 102. As an example, the authentication component 104 may clear the opaque data/authentication session cookie. This may ensure that subsequent authorization requests are forced to perform authentication again. In one example, the authentication component 104 sets the state of the opaque data/authentication session cookie to ‘done’ indicating that authentication validation has been completed. Alternatively, if the client 102 failed authentication, the opaque data/authentication session cookie is updated to reflect that the client 102 is untrusted, for example where the state field of the opaque data/authentication session cookie is set to ‘incapable’. As an example, on subsequent redirects made by the authentication component 104 such as requesting user authentication of the client 102, the authentication component 104 may suppress an authentication challenge if the state field of the opaque data/authentication session cookie identifies that the authentication process has been conducted on the client (e.g., state field indicates ‘done’ or ‘incapable’).

After update of the data opaque to the client/authentication session cookie, the client 102 or the authentication component 104 may require additional levels of authentication. For example, in a case where a device authentication was performed during an initial authentication challenge, a user authentication of the client 102 may still need to be performed (or alternatively another form of authentication such as service or process authentication etc., may need be performed). In this instance, flow proceeds to operation 210 where an additional authentication request is sent by the client 102 and received at the authentication component 104. In an example, the authentication protocol may allow optimistic authentication across resources where the client and the authentication component (e.g., IDP) remain the same. In an example, the client 102 may present the authentication artifact along with the authentication request to an authentication component that originally issued the authentication artifact. In other examples, policies may be implemented to handle examples where at least one of the client 102 and the authentication component 104 changes. The authentication component 104 evaluates the most recent authentication request including identifying that the client 102 provided an authentication artifact proving that the client 102 has already been authenticated. This may result in the authentication component 104 suppressing an authentication challenge, where suppression of multiple challenges that may not be required improves an overall experience for an end user. If the opaque data/authentication session cookie was updated prior to performing an authentication, the authentication component 104 may identify this from data transmitted by the client 102 and the authentication component 104 may determine that the client 102 should not be prompted with another authentication challenge.

While additional challenges may be suppressed for an already authenticated client 102, the authentication component 104 may still perform a process of validating the user of the client 102. The authentication component 104 may further validate that the authentication artifact is valid (e.g., the authentication artifact is the same authentication artifact that was originally issued). The authentication component 104 may further validate that aspects of the authentication artifact would be the same if generating a new challenge (e.g., the policy or policies used for the authentication). In the example where user authentication is to be performed after the client 102 is authenticated, the user may simply be prompted for user logon information. In other examples, the authentication component 104 may enable variations of single sign-on, where in one example, a single sign-on is performed at the initial authentication that authenticates the client 102 for access to more than one resource.

When additional validation is performed after an initial authentication occurs, flow of method 200 proceeds to operation 212 where the authentication artifact may be updated. As described previously, the authenticate artifact is updated before additional authentication is performed following an initial authentication. The authentication component 104 may further update the authentication artifact (operation 212) when additional authentication is performed.

An exemplary authentication component 104 protects authentication artifacts from being misused. As an example, the authentication component 104 may tie an authentication artifact to a client that the authentication artifact was initially issued to. In an example where a device of a client seeks access to multiple secured resources (e.g., network resources 110, 112, 114 of FIG. 1), the client is required to be authenticated to be granted access to such resources. Authentication of the client device is performed in accordance with the mechanisms described above for performing an authentication of a client. An authentication component (such as the authentication component 104 of FIGS. 1-2) may generate an authentication artifact (e.g., single sign-on cookie or authentication token) to represent the fact that the client is authenticated if the client device is determined to be authenticated to access a resource. Information pertaining to the client device (e.g., identifier information) may be embedded within the authentication artifact. Once the authentication artifact is generated, the authentication component sends the authentication artifact to the authenticated client device. When the client accesses another resource, the client may present the authentication artifact to prove that the client has already been authenticated by the authentication component. This provides single sign-on, for example, where authentication credential prompts such as authentication challenges may be suppressed. The authentication component may authenticate the client device in accordance with the mechanisms described in the present disclosure for performing an authentication of a client.

Further, the authentication component 104 may validate that the client device presenting the authentication artifact is the same device that the authentication artifact was originally issued to. As an example, the authentication component 104 accomplishes validation of the authentication artifact by validating the authentication artifact presented by the client device against device information stored at the authentication component 104. In an example where the device information presented by the client device does not match that stored by the authentication component 104, the authentication artifact may be dishonored or invalidated, thus forcing the client device to re-authenticate. As a result of this, another device, other than the client device that was originally issued the authentication artifact, is unable to use the authentication artifact to access secure resources. In an example, where the authentication artifact is validated by the authentication component 104, the client device is granted access to the resource or additional resources.

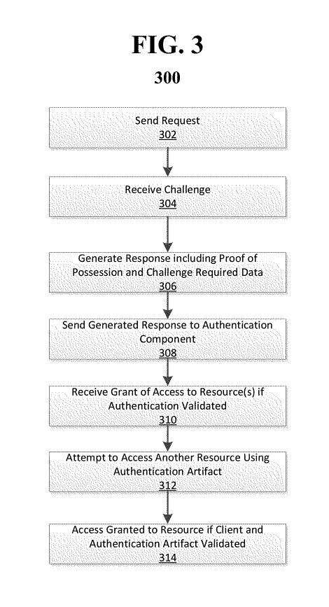

FIG. 3 illustrates a method 300 for request generation and response processing performed by a client as described herein. Method 300 may be a computer-implemented method that is configurable to perform operations on a component such as the client 102 of the system 100 described in FIG. 1, or any computing or processing device that includes processing means and storage means to accommodate authentication of the client 102.

Flow of method 300 begins at operation 302 where a request is sent by a client to an authentication component. In response to receiving the request, the authentication component generates an authentication challenge. Flow proceeds to operation 304 where the client receives the authentication challenge.

Once the client receives the authentication challenge, the client may use the authentication challenge to locate an authentication credential. Authentication credentials may be stored on a storage of the client and a single authentication credential may be difficult to identify without indication from the authentication component. An authentication credential may be any data that is able to authenticate a client to access a network resource. The authentication component may include enforcement criteria in the authentication challenge to assist the client in identifying an authentication credential to include in a challenge response.

Proceeding to operation 306, the client generates a response to the authentication challenge. The response may include proof of possession that the client actually possesses the authentication credential. In some examples, the authentication component may require that the client provide additional context data for proving proof of possession of the authentication credential. Generation of the response may also include challenge required data. Challenge required data may be data specific to the challenge issued by the authentication component. Examples of challenge required data, may include a nonce value, for example or other data that the authentication component is able to use to validate the client. The client includes the authentication credential, the challenge required data, and signs the response.

After the response is generated and signed, method 300 proceeds to operation 308 where the response to the challenge is sent to an authentication component. Once the authentication component evaluates the response the challenge, flow proceeds to operation 310 where the client receives a validation result from the authentication component. The validation result may include an authentication artifact if the client is authenticated by the authentication component. In some cases, access may still be granted to a resource even if the client fails authentication. Policy rules for access to resources may be vary depending on administration.

Method 300 may proceed to operation 312 where the client attempts to access another resource using an issued authentication artifact. In that example, the authentication component may evaluate both the client and the authentication artifact. If the authentication artifact was not originally issued to the client requesting access, then then client is not granted access based on the authentication artifact and the client would be required to re-authenticate. When both the client and the authentication artifact are validated, flow may proceed to operation 314 where the client is granted access to the secured resource.

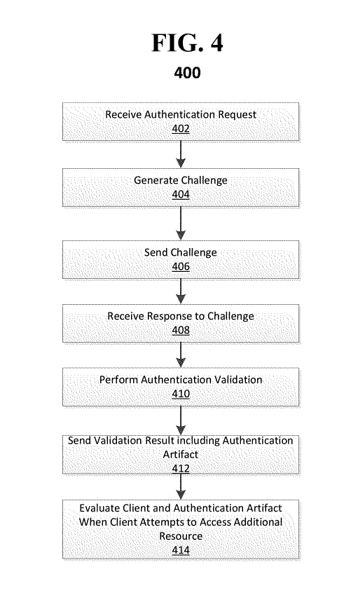

FIG. 4 is a method 400 for request and challenge processing performed by an authentication component as described herein. Method 400 may be a computer-implemented method that is configurable to perform operations on a component such as the authentication component 104 of the system 100 described in FIG. 1, or any computing or processing device that includes processing means and storage means for authentication.

Method 400 begins at operation 402 where an authentication request is received by the authentication component. Based on receipt of the request, the authentication component may generate an authentication challenge (operation 404). The authentication challenge may include criteria to assist a client in selecting an appropriate authentication credential, a request for proof of possession of the authentication credential, and challenge-specific data for the client to return in a challenge response. Once the authentication challenge is generated, the authentication component may send the authentication challenge to a client (operation 406) allowing the client to access a network resource.

The client may generate a response to the challenge and send the response to the authentication component. The authentication component receives the challenge response at operation 408. From there, the authentication component may perform an authentication process to validate the client (operation 410). Refer to the description of FIG. 2 for a detailed description of evaluation and processing of a challenge response sent by a client. Validation of the client may be performed by the authorization component, which sends an authentication or validation result to the client (operation 412). In sending the authentication result, the authentication component may include an authentication artifact to enable the client to access a secured network resource.

In an example where the client seeks access to another secured resource, the authentication component evaluates the client and an authentication artifact if one is presented. If an authentication artifact is not presented by the client, then an authentication protocol of the authentication component may require that a challenge-based authentication be initiated to authenticate the client. When an authentication artifact is presented by the client, the authentication component may validate the authentication artifact in addition to authenticating the client. As an example, the authentication component accomplishes validation of the authentication artifact by validating the authentication artifact presented by the client against client-specific information stored at the authentication component. In an example where the data of the authentication artifact presented by the client does not match that stored by the authentication component, the authentication artifact may be dishonored or invalidated, thus forcing the client to re-authenticate. In an example, where the authentication artifact is validated by the authentication component and the client is also authenticated, the authentication component grants the client access to the additional resource(s).

In addition to authenticating components of a system or network, the authentication component implementing an authentication protocol may provide additional capabilities. For example, the authentication component may enable administrators to configure auditing for authentication performed by the authentication component. Auditing may be performed on client components that have both successfully authenticated or have failed authentication. The authentication component may also enable maintenance updates, back-porting capabilities, and enable optimistic authentication (as discussed with respect to FIG. 1), among other capabilities.

FIGS. 5-7 and the associated descriptions provide a discussion of a variety of operating environments in which examples of the invention may be practiced. However, the devices and systems illustrated and discussed with respect to FIGS. 5-7 are for purposes of example and illustration and are not limiting of a vast number of computing device configurations that may be utilized for practicing examples of the invention, described herein.

FIG. 5 is a block diagram illustrating physical components of a computing device 502, for example a client 102 and an authentication component 104 as described herein, with which examples of the present disclosure may be practiced. The computing device components described below may be suitable for the computing devices described above. In a basic configuration, the computing device 502 may include at least one processing unit 504 and a system memory 506. Depending on the configuration and type of computing device, the system memory 506 may comprise, but is not limited to, volatile storage (e.g., random access memory), non-volatile storage (e.g., read-only memory), flash memory, or any combination of such memories. The system memory 506 may include an operating system 507 and one or more program modules 508 suitable for running software applications 520 such as a virtual file system 108, IO manager 524, and other utility 526. The operating system 507, for example, may be suitable for controlling the operation of the computing device 502. Furthermore, examples of the invention may be practiced in conjunction with a graphics library, other operating systems, or any other application program and is not limited to any particular application or system. This basic configuration is illustrated in FIG. 5 by those components within a dashed line 522. The computing device 502 may have additional features or functionality. For example, the computing device 502 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 506. While executing on the processing unit 504, the program modules 508 (e.g., Input/Output (I/O) manager 524, other utility 526 and application 528) may perform processes including, but not limited to, one or more of the stages of the operational flows illustrated in FIGS. 2-4, for example. Other program modules that may be used in accordance with examples of the present invention may include electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 502 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 502 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 504 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 506, the removable storage device 509, and the non-removable storage device 510 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 502. Any such computer storage media may be part of the computing device 502. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

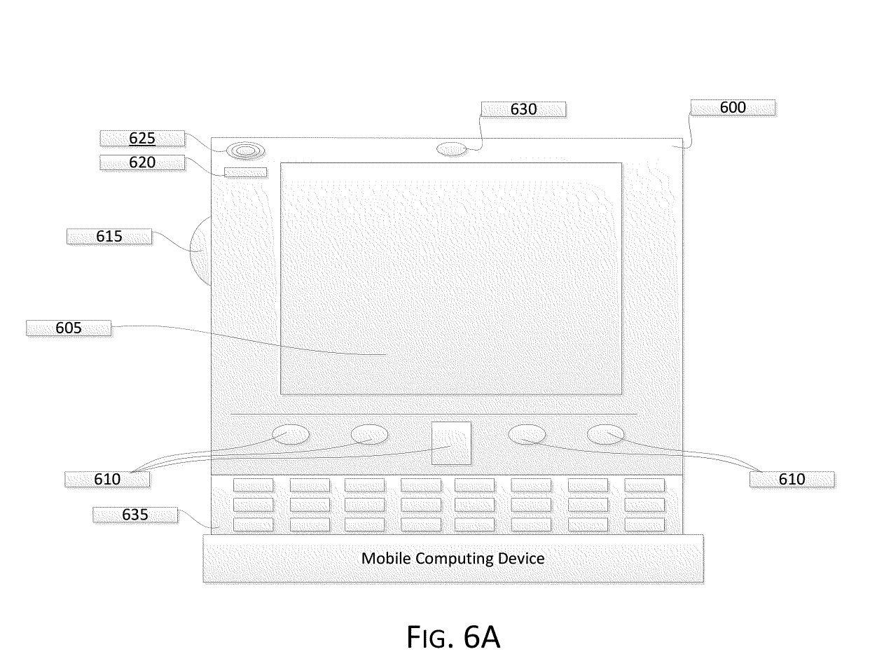

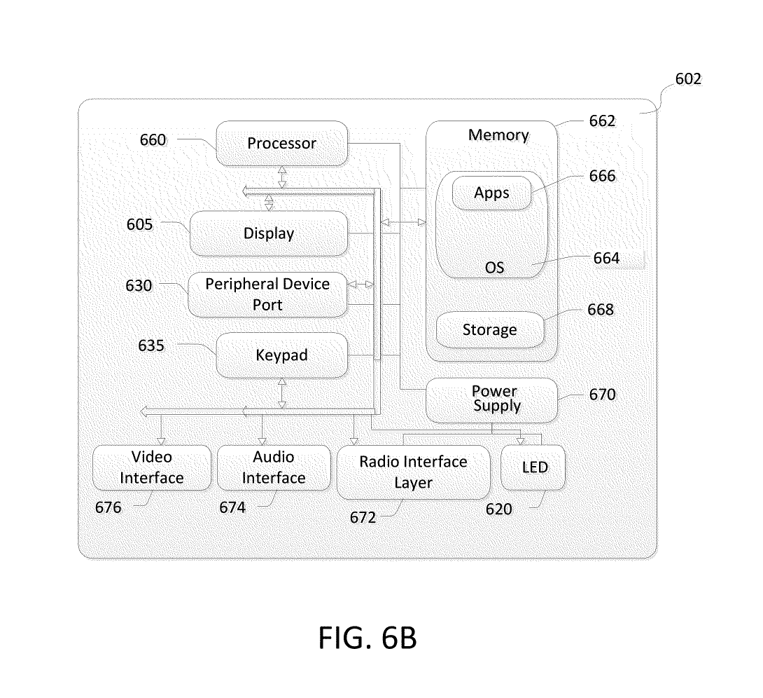

FIGS. 6A and 6B illustrate a mobile computing device 600, for example, a mobile telephone, a smart phone, a tablet personal computer, a laptop computer, and the like, with which examples of the invention may be practiced. For example, mobile computing device 600 may be used to implement client 102, authentication component 104 or resources 110, 112 and 114. With reference to FIG. 6A, one example of a mobile computing device 600 for implementing the examples is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative examples, mobile computing device 600 may incorporate more or less input elements. For example, the display 605 may not be a touch screen in some examples. In yet another alternative example, the mobile computing device 600 is a portable phone system, such as a cellular phone. The mobile computing device 600 may also include an optional keypad 635. Optional keypad 635 may be a physical keypad or a “soft” keypad generated on the touch screen display. In various examples, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 can incorporate a system (i.e., an architecture) 602 to implement some examples. In one examples, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including IO manager 524, other utility 526 and application 528 described herein.

The system 602 has a power supply 670, which may be implemented as one or more batteries. The power supply 670 might further include an external power source, such as an AC adapter or a powered docking cradle that supplements or recharges the batteries.

The system 602 may include peripheral device port 678 that performs the function of facilitating connectivity between system 602 and one or more peripheral devices. Transmissions to and from the peripheral device port 672 are conducted under control of the operating system 664. In other words, communications received by the peripheral device port 678 may be disseminated to the application programs 666 via the operating system 664, and vice versa.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with examples of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

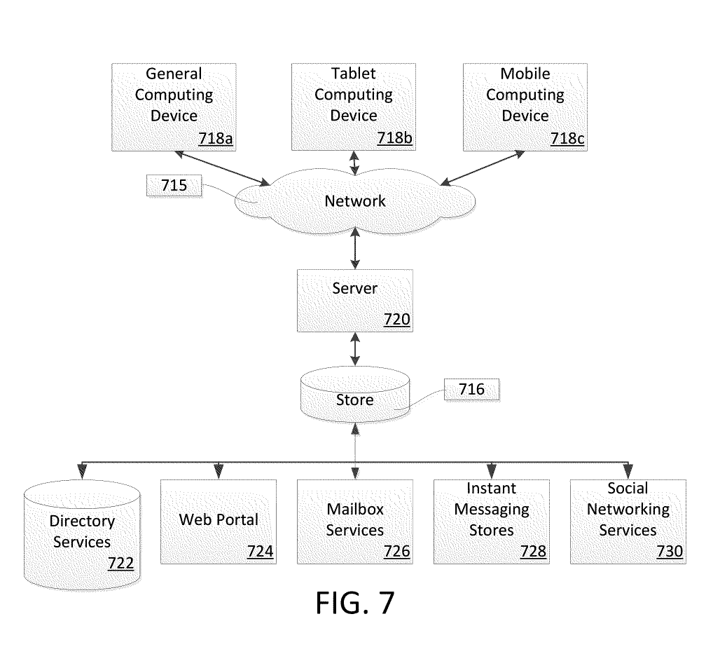

FIG. 7 illustrates one example of the architecture of a system for providing an application that reliably accesses target data on a storage system and handles communication failures to one or more client devices, as described above. Target data accessed, interacted with, or edited in association with IO manager 524, other utility 526, application 528 and storage may be stored in different communication channels or other storage types. For example, various documents may be stored using a directory service 722, a web portal 724, a mailbox service 726, an instant messaging store 728, or a social networking site 730, IO manager 524, other utility 526, application 528 and storage systems may use any of these types of systems or the like for enabling data utilization, as described herein. A server 720 may provide storage system for use by a client operating on general computing device 502 and mobile device(s) 600 through network 715. By way of example, network 715 may comprise the Internet or any other type of local or wide area network, and client nodes may be implemented as a computing device 502 embodied in a personal computer, a tablet computing device, and/or by a mobile computing device 600 (e.g., a smart phone). Any of these examples of the client computing device 502 or 600 may obtain content from the store 716.

Non-limiting examples of the present disclosure comprise systems and methods for authentication of a client to access a secured resource. An access request is received from a client at an authentication component. In one example, the authentication component analyzes the received access request and detects a capability of the client to respond to an authentication protocol by inspecting a user string or header of the access request, and generates the authentication challenge based on the detected capability of the client. As an example, before generating the authentication challenge, the authentication component determines whether the client has issued a response to a previously issued authentication challenge and if opaque data has been generated for the client, wherein the opaque data indicates a state of an access request or previously issued authentication challenge. The authentication component generates an authentication challenge including criteria to assist the client in selecting an appropriate authentication credential, a request for proof of possession of the authentication credential, and challenge-specific data for the client to return in a challenge response. In one example, the criteria to assist the client in selecting the appropriate authentication credential, included in the authentication challenge, comprises data related to an issuer of the authentication credential. As an example, the challenge-specific data included in the authentication challenge comprises state information that is opaque to the client, and wherein the state information includes a timestamp that the authentication component evaluates in evaluation of the challenge response. In another example, the generated authentication challenge comprises rules regarding a format for the client to return the challenge response, and the authentication component evaluates the format of the challenge response in the evaluating. A challenge response is received from the client. The authentication component evaluates the challenge response. In examples, evaluating of the challenge response further comprises checking a digital signature in accordance with signing specification of the authentication protocol, extracting the authentication credential from the challenge response, validating the authentication credential against data maintained by the authentication component, and validating the challenge specific data provided by the client. The authentication component determines whether to authenticate the client for access to a resource based on the evaluated challenge response. As an example, determining whether to authenticate the client further comprises generating a validation result indicating whether the client is authenticated, and transmitting the validation result comprising an authentication artifact identifying a state of authentication of the client.

In another example, an exemplary system of the present disclosure comprises a device having a memory and a processor. The processor is configured to suppress an authentication challenge when the authentication artifact is presented corresponding with a request for access to a secured resource. The processor is further configured to determine whether a client associated with the request is authenticated, and evaluate the authentication artifact to determine whether the authentication artifact is valid. The device determines that the authentication artifact is valid when the authentication artifact presented is an authentication artifact that was issued to the client requesting access to the secured resource. The device grants access to the secured resource when the client is authenticated and the authentication artifact is valid. In yet another example, the device requires the client to re-authenticate when at least one of, the client fails authentication and the authentication artifact is determined to be invalid, occurs. If the device determines that the client is to authenticate or re-authenticate, the device issues an authentication challenge.

Yet another non-limiting example describes a computer-readable storage device, having instructions thereon, which when executed on a process cause the processor to execute a process. The process executed comprises storing data extracted from a received authentication challenge. The stored data extracted from the received authentication challenge is modified. An access request is generated including the modified stored data and the generated access request is transmitted for authentication.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A system comprising:
a memory; and
a processor connected with the memory, the processor executing operations comprising:
receiving, at an authentication component, an access request from a client,
generating an authentication challenge including criteria to assist the client in selecting an appropriate authentication credential, a request for proof of possession of the authentication credential, and challenge-specific data for the client to return in a challenge response,
receiving the challenge response from the client,
evaluating the challenge response, and
determining whether to authenticate the client for access to a resource based on the evaluated challenge response.

2. The system according to claim 1, wherein the authentication component analyzes the received access request and detects a capability of the client to respond to an authentication protocol by inspecting a user string or header of the access request, and generates the authentication challenge based on the detected capability of the client.

3. The system according to claim 1, wherein before generating the authentication challenge, the authentication component determines whether the client has issued a response to a previously issued authentication challenge and if opaque data has been generated for the client, wherein the opaque data indicates a state of an access request or previously issued authentication challenge.

4. The system according to claim 1, wherein the criteria to assist the client in selecting the appropriate authentication credential, included in the authentication challenge, comprises data related to an issuer of the authentication credential.

5. The system according to claim 1, wherein the challenge-specific data included in the authentication challenge comprises state information that is opaque to the client, and wherein the state information includes a timestamp that the authentication component evaluates in evaluation of the challenge response.

6. The system according to claim 1, wherein the generated authentication challenge comprises rules regarding a format for the client to return the challenge response, and the authentication component evaluates the format of the challenge response in the evaluating.

7. The system according to claim 1, wherein the evaluating of the challenge response further comprises checking a digital signature in accordance with signing specification of the authentication protocol, extracting the authentication credential from the challenge response, validating the authentication credential against data maintained by the authentication component, and validating the challenge specific data provided by the client.

8. The system according to claim 1, wherein the determining whether to authenticate the client further comprises generating a validation result indicating whether the client is authenticated, and transmitting the validation result comprising an authentication artifact identifying a state of authentication of the client.

9. A computer-implemented method comprising:
receiving, by an authentication component, an access request from a client;
generating an authentication challenge including criteria to assist the client in selecting an appropriate authentication credential, a request for proof of possession of the authentication credential, and challenge-specific data for the client to return in a challenge response;
receiving the challenge response from the client;
evaluating the challenge response; and
determining whether to authenticate the client for access to a resource based on the evaluated challenge response.

10. The computer-implemented method according to claim 9, wherein the authentication component analyzes the received access request and detects a capability of the client to respond to an authentication protocol by inspecting a user string or header of the access request, and generates the authentication challenge based on the detected capability of the client.

11. The computer-implemented method according to claim 9, wherein the criteria to assist the client in selecting the appropriate authentication credential, included in the authentication challenge, comprises data related to an issuer of the authentication credential.

12. The computer-implemented method according to claim 9, wherein the challenge-specific data included in the authentication challenge comprises state information that is opaque to the client, and wherein the state information includes a timestamp that the authentication component evaluates in evaluation of the challenge response.

13. The computer-implemented method according to claim 9, wherein the generated authentication challenge comprises rules regarding a format for the client to return the challenge response, and the authentication component evaluates the format of the challenge response in the evaluating.

14. The computer-implemented method according to claim 9, wherein the evaluating of the challenge response further comprises checking a digital signature in accordance with signing specification of the authentication protocol, extracting the authentication credential from the challenge response, validating the authentication credential against data maintained by the authentication component, and validating the challenge specific data provided by the client.

15. The computer-implemented method according to claim 9, wherein the determining whether to authenticate the client further comprises generating a validation result indicating whether the client is authenticated, and transmitting the validation result comprising an authentication artifact identifying a state of authentication of the client.

16. A system comprising:
a device having a memory connected with a processor, the processor configured to:
suppress an authentication challenge when an authentication artifact is presented corresponding with a request for access to a secured resource,
determine whether a client associated with the request is authenticated, and
evaluate the authentication artifact to determine whether the authentication artifact is valid, wherein the authentication artifact is determined to be valid when it is determined that the authentication artifact presented is an authentication artifact that was issued to the client requesting access to the secured resource.

17. The system according to claim 16, wherein the processor is further configured to grant access to the secured resource when the client is authenticated and the authentication artifact is valid.

18. The system according to claim 16, wherein the processor is further configured to require the client to re-authenticate when at least one of, the client fails authentication and the authentication artifact is determined to be invalid, occurs.

19. The system according to claim 18, wherein the processor is further configured to issue an authentication challenge when it is determined that the client is to authenticate or re-authenticate.

20. A computer-readable storage device, having instructions thereon, which when executed by a processor cause the processor to execute operations comprising:
storing data extracted from a received authentication challenge;
modifying the stored data extracted from the received authentication challenge;
generating an access request including the modified stored data; and
transmitting the generated access request for authentication.
